(19) United States
(12) Patent Application Publication
(10) Pub. No.: US 2017/0261757 A1
(43) Pub. Date: Sep. 14, 2017

(54) MOBILE DEVICE PACKING BOX TO WATCH STEREO-SCOPIC CONTENTS

(71) Applicant: Hyuk Jae Choi, Seoul (KR)

(72) Inventor: Hyuk Jae Choi, Seoul (KR)

(21) Appl. No.: 15/109,613

(22) PCT Filed: Nov. 19, 2015
(86) PCT No.: PCT/KR2015/012449

§ 371 Date: Jul. 1, 2016

(51) Int. Cl. G02B 27/22; B65D 81/36; B65D 85/38; B65D 65/02; A45F 5/00; B65D 25/04; B65D 25/14

(52) U.S. Cl. CPC G02B 27/2242; B65D 25/04; B65D 81/36; B65D 25/14; B65D 65/02; A45F 5/00; B65D 85/38

(57) ABSTRACT

A terminal packing box capable of viewing stereoscopic image is provided, which includes a terminal box for encasing therein a mobile terminal, and a face connecting portion being connected in a manner of surrounding a lower portion of the terminal box, and comprising a pair of eye-contact holes passed therethrough, in which the terminal box includes a box body to which a cover is openably engaged, a partition vertically fastened within the box body to divide the box body into two spaces, a pair of convex lenses fastened to the lower portion of the box body, and a terminal support disposed between the partition and the cover to hold the mobile terminal thereon.

### TECHNICAL FIELD

The present disclosure relates to a terminal packing box, and more particularly, to a terminal packing box used for the purpose of packing a mobile terminal, and is then assembled and re-used as a stereoscopic image viewer.

### BACKGROUND ART

The recent advancement in the 3D stereoscopic image contents production and display technology has led into production of a variety of 3D movies and images. Further, according to development of a mobile terminal technology, 3D image contents are now available to watch on mobile terminals.

The basic principle of the stereoscopic images lies in the binocular disparity. The ‘binocular disparity’ refers to a presence of difference between an image viewed by a left eye and an image viewed by a right-eye, which corresponds to the distance between the two eyes. This enables a viewer to feel depth of an object.

In order to view stereoscopic images, a viewer has to wear stereoscopic image viewing glasses. One example of the stereoscopic image viewing glasses has been disclosed in Korean Patent Application Publication No. 10-2012-0047712, entitled “Stereoscopic image viewing glasses and stereoscopic image viewing method using the same”.

Conventionally, the user has to purchase the stereoscopic image viewing glasses separately, which are often expensive. Accordingly, there is reluctance to buy the glasses.

### DISCLOSURE OF THE INVENTION

### Technical Problem

An object of the present disclosure is to solve the problems mentioned above, and accordingly, it is an object of the present disclosure to provide a terminal packing box for packing a mobile terminal therein such that once purchased, the packing box can be recycled as a stereoscopic image viewer.

Another object of the present disclosure is to provide a terminal packing box that a user can re-use as a stereoscopic image viewer with convenience, by assembling only the components as provided without requiring additional secondary processing.

Yet another object of the present disclosure is to provide a terminal packing box whose interior is divided into two spaces to allow two eyes to view different images from each other, thus increasing user's absorbance into the stereoscopic images.

The above and other various advantages will be made apparent to those skilled in the art by referring to the preferred embodiments described herein.

### Technical Solution

The above and other objects can be achieved by a terminal packing box capable of viewing stereoscopic image, which may include a terminal box for encasing therein a mobile terminal, and a face connecting portion being connected in a manner of surrounding a lower portion of the terminal box, and comprising a pair of eye-contact holes passed therethrough. The terminal box may include a box body to which a cover is openably engaged, a partition vertically fastened within the box body to divide the box body into two spaces, a pair of convex lenses fastened to the lower portion of the box body, and a terminal support disposed between the partition and the cover to hold the mobile terminal thereon. In an unpacked state in which the encased mobile terminal is released from the packed state, the face connecting portion may be separated from the terminal box and assembled with the lower portion of the terminal box such that the terminal packing box is usable as a stereoscopic image viewer.

According to an exemplary embodiment, the terminal box may include a plurality of face insertion holes passed through along an edge area. The face connecting portion may include a plurality of fastening protrusions protruding toward the lower portion to be inserted into the face insertion holes.

According to an exemplary embodiment, the partition may be fastened to the box body at a spacing from the cover that corresponds to a height for encasing the mobile terminal, and the terminal support may include a holder frame for contact-supporting an outer circumference of the mobile terminal, and including a terminal exposure hole passed therethrough to expose a liquid crystal screen of the mobile terminal to a direction of the convex lens, and a box holding wings extending from both ends of the holder frame and seated on an upper end of the box body.

According to an exemplary embodiment, a darkening layer may be formed on an inner surface thereof.

According to an exemplary embodiment, the face connecting portion may be formed in a curved shape to correspond to a contour of a face of a user.

According to an exemplary embodiment, in the packed state, a packing material is further provided, which is wrapped around an exterior of the terminal box and the face connecting portion being engaged in a stack manner, to fix these in position.

According to an exemplary embodiment, the terminal packing box may additionally include a box head fixing portion for fixing the terminal box with the face connecting portion being connected thereto for use as a stereoscopic image viewer, onto the face of the user. A plurality of hook insertion holes may be passed through a side surface of the terminal box. The box head fixing portion may include a band fixing plate disposed on a back of a head of the user, an upper fixing band extending from an upper portion of the band fixing plate to be fit into the terminal box, and a pair of side fixing bands extending from both sides of the band fixing plate to be fit into the terminal box.

### Advantageous Effects

As described above, according to the present disclosure, a terminal packing box can be used for the purpose of packing a mobile terminal being shipped, and then reassembled and re-used as a stereoscopic image viewer. Accordingly, the user does not have to separately purchase expensive stereoscopic image viewer, as he or she can assemble the terminal packing box into the stereoscopic image viewer.

Further, the user does not need separate processing to assemble the packing box, as he or she can simply assemble only with a terminal box and a face connecting portion that are provided.

Further, since the interior of the lower box is divided by a partition into two spaces and the left-eye image and the right-eye image are separately provided, the user can have increased absorbance into the stereoscopic images.

Further, since a box head fastening portion secures the terminal packing box onto a head of the user, the user can view the stereoscopic images conveniently for long time.

### BRIEF DESCRIPTION OF THE DRAWINGS

FIG. 1 is a perspective view of a terminal packing box packing a mobile terminal therein, according to an exemplary embodiment of the present disclosure.

FIG. 2 is an exploded perspective view illustrating a terminal packing box packing a mobile terminal therein, according to an exemplary embodiment of the present disclosure.

FIG. 3 is an exploded perspective view illustrating a process of assembling a terminal packing box into a stereoscopic image viewer, according to an exemplary embodiment of the present disclosure.

FIG. 4 is a perspective view illustrating a state of a terminal packing box being assembled into a stereoscopic image viewer, according to an exemplary embodiment of the present disclosure.

FIG. 5 is a cross sectional view taken along line A-A of FIG. 5.

FIG. 6 is an exemplary view of a terminal packing box being used in a stereoscopic image viewing state.

FIGS. 7 and 8 are perspective views of a terminal packing box according to another exemplary embodiment of the present disclosure.

FIGS. 9 to 11 are perspective views of a terminal packing box according to yet another exemplary embodiment of the present disclosure.

### BEST MODE FOR CARRYING OUT THE INVENTION

The preferred exemplary embodiments will be described below with reference to the accompanying drawings to help understand the present disclosure sufficiently. Exemplary embodiments of the present disclosure may have a variety of modifications, and the scope of the present disclosure should not be construed as being limited to only the exemplary embodiments described herein. The exemplary embodiments are provided only to help those with ordinary knowledge in the art to understand the present disclosure more fully. Accordingly, the shapes of the elements in the drawings may be exaggerated to emphasize clearer description. The same or like elements in the drawings may be referred to by the same reference numerals throughout. The detailed description of the known functions and configurations can be omitted as these may obscure the concept of the present disclosure.

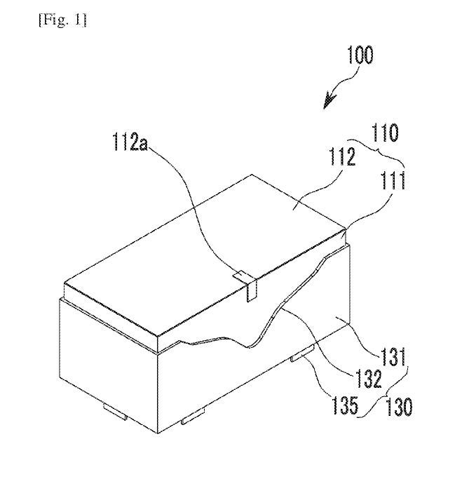

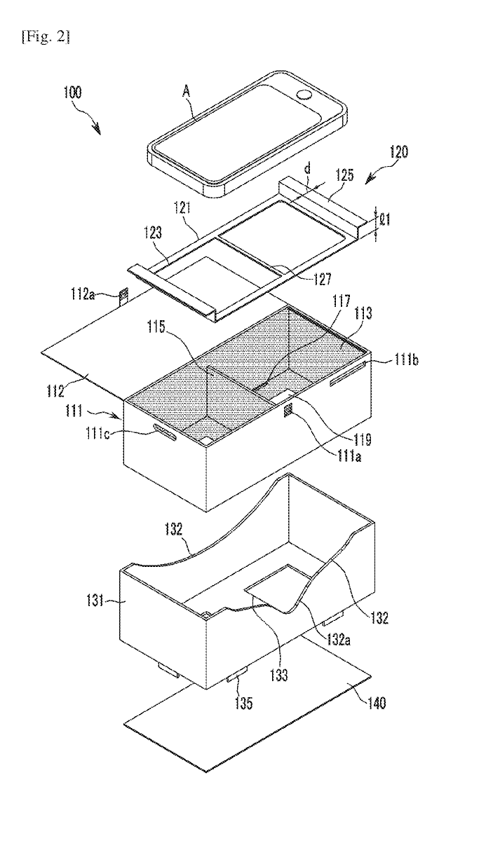

FIG. 1 is a perspective view of a terminal packing box 100 being in assembled state for the purpose of packing a mobile terminal A, and FIG. 2 is an exploded perspective view illustrating a disassembled structure when being used for the purpose of packing the mobile terminal A.

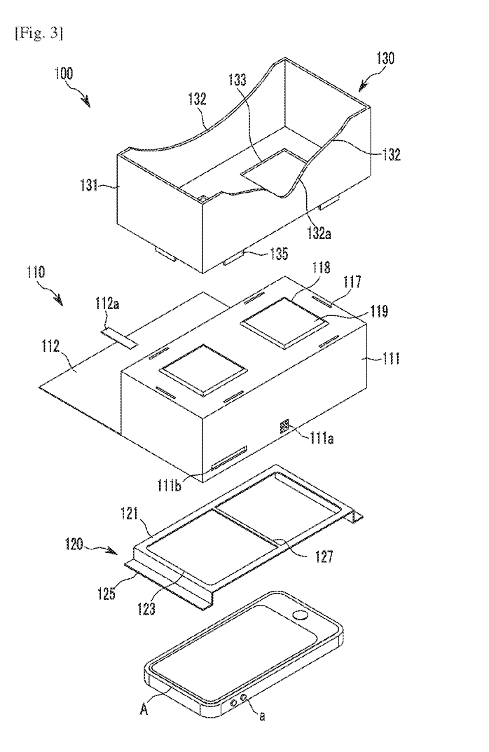

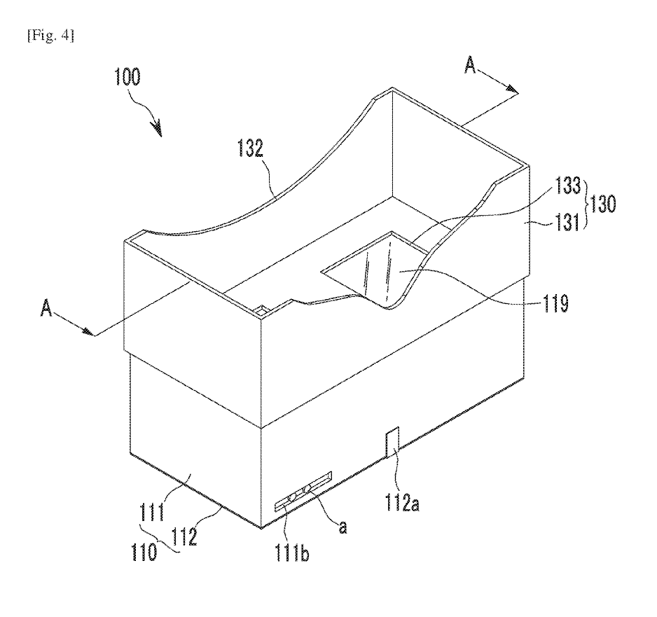

FIG. 3 is a perspective view illustrating a process of recycling the terminal packing box 100 as a stereoscopic image viewer, and FIG. 4 is a perspective view illustrating the terminal packing box 100 being reassembled into a stereoscopic image viewer.

As illustrated in FIG. 1, the terminal packing box 100 according to the present disclosure includes a terminal box 110 for encasing a mobile terminal A therein, a face connecting portion 130 for receiving a lower portion of the terminal box 110, and a protective cover 140 for protecting a lower surface (i.e., convex lens 119) of the terminal box 110.

According to the present disclosure, the terminal packing box 100 is manufactured for the purpose of packing the mobile terminal A. It is thus shipped in the state of packing the mobile terminal A therein, and after a user who purchased the mobile terminal A tears open packing tapes and separates the mobile terminal A from the terminal packing box 100, the user may reassemble the terminal packing box 100 as illustrated in FIG. 3 and recycle it as a stereoscopic image viewer.

That is, according to the present disclosure, the terminal packing box 100 is manufactured for the purpose of packing the mobile terminal, and then additionally used as a stereoscopic image viewer. In this case, the user who has purchased the mobile terminal A can have a stereoscopic image viewer by a simple assembling step without requiring any separate secondary processing. In this case, the terminal packing box 100 can be formed in an optimum size to accommodate a corresponding mobile terminal A and thus may serve as a stereoscopic image viewer with which the stereoscopic images provided from the mobile terminal A can be stably viewed.

In this case, the terminal packing box 100 according to the present disclosure may be used for the purpose of packing all types of mobile terminals including smartphones, tablet PCs, PDPs, PMP, and so on.

When the terminal packing box 100 according to the present disclosure is used for the purpose of packing a mobile terminal A, the terminal box 110 accommodates therein the mobile terminal A along with the associated components. Although FIG. 2 illustrates only the mobile terminal A, the accessory such as headphone, charger cable, auxiliary battery, and so on, may be accommodated inside the terminal box 110.

The terminal box 110 includes a boxy body 111 having an accommodating space where the mobile terminal A is accommodated, a cover 112 openably coupled to an upper portion of the box body 111, a partition 115 vertically coupled at a center area of the box body 111 to divide the box body 111 into two independent spaces, and a convex lens 119 provided at a lower portion of the box body 111.

The box body 111 is formed as an enclosure. An upper end of the box body 111 is open, and opened and closed by the cover 112. The upper portion of the box body 111 is defined as a portion where the cover 112 is coupled, and the lower portion is defined as a portion where the convex lens 119 is coupled.

The box body 111 is formed to a predetermined height such that the stereoscopic images provided by the mobile terminal A is provided at a predetermined distance to the eyes of the user. That is, the height may preferably be at least four times the thickness of the mobile terminal A.

The cover 112 opens and closes the open upper end of the box body 111 such that a user may insert the mobile terminal A into the box body 111 when he or she wants to view the stereoscopic image, or separate it therefrom. In this case, a female Velcro 112a of a predetermined length is provided on a surface of the cover 112, and a male Velcro 111a is provided on the box boxy 111. The female Velcro 112a and the male Velcro 111a are engaged with each other, thus maintaining the box body 111 in the closed state. As such, separating of the mobile terminal A from the terminal box 110 can be prevented while the terminal packing box 100 is used as the stereoscopic image viewer.

Meanwhile, a volume adjustment hole 111b is provided on the side surface of the box body 111 such that when the box body 111 is used as the stereoscopic image viewer, the volume adjustment button (a) of the mobile terminal A is exposed to outside for the user to adjust the volume. Further, a power supply hole 111c is passed through the other side of the box body 111 to connect a power supply jack (not illustrated) to the mobile terminal A. Accordingly, the mobile terminal A turning off can be prevented especially during long time of use.

Further, although not illustrated, a headphone insertion hole (not illustrated) may also be passed through one side of the box body 111 to allow a headphone (not illustrated) to be inserted.

A darkened layer 113 is formed on an inner surface of the box body 111. The darkening layer 113 darkens the interior space to a state like a theater with lights off so that the user is more absorbed into the stereoscopic images. The darkening layer 113 may be formed by painting the inner surface of the box body 111 with black ink or coating it with black film.

The partition 115 divides the box body 111 into two separate spaces. Accordingly, the images for viewing by the left eye and right eye of the user are independently separated. Accordingly, the user views separates image and thus can feel increased feeling of depth.

An outer surface of the partition 115 is provided in black color. Along with the darkening layer 113 of the box body 111, this allows darker space for providing the stereoscopic images such that the user can have increased absorbance and attention to the stereoscopic images.

The height (h) of the partition 115 is a height of the box body 111 less the thickness of the mobile terminal A. The mobile terminal support 120 is held on the upper portion of the partition 115.

A plurality of face insertion holes 117 is passed through the outer circumference of the box body 111. Fastening protrusions 135 of the face connecting portion 135 are inserted into the face insertion holes 117. The face insertion holes 117 are provided in a number and a shape that correspond to those of the fastening protrusions 135. In this case, the face insertion holes 117 are provided in a size that allows the fastening protrusions 135 to be fastened such that the face connecting portion 130 is stably maintained in a state of being coupled with the terminal box 110.

A pair of lens fastening holes 118 are provided in a predetermined size at a lower portion of the box body 111. The convex lenses 119 are fit in the lens convex holes 118. The convex lens 119 may be implemented as a plastic film or glass lens. The convex lens 119 may be formed in not only a circular shape as illustrated, but also rectangular or polygonal shape.

In this case, the protective cover 140 for preventing contamination of the convex lenses 119 is attached to the lower surface of the box body 111. In the packed state, the protective cover 140 is kept being attached to the box body 111, or when the terminal packing box 100 is used as the stereoscopic image viewer, the user separates the protective cover 140 from the convex lens 119.

The mobile terminal support 120 is disposed in the space between the partition 115 and the cover 112 to support the mobile terminal A. As illustrated in FIG. 2, in the mobile terminal A packing state, the mobile terminal support 120 holds the mobile terminal A such that the liquid crystal screen of the mobile terminal A is faced toward the cover 112, or when the stereoscopic image viewer is used, as illustrated in FIG. 3, the mobile terminal support 120 holds the mobile terminal A such that the liquid crystal screen of the mobile terminal A is faced toward the convex lens 119.

The mobile terminal support 120 includes a holder frame 121 that holds the outer circumference of the mobile terminal A, and box holding wings 125 extending from both sides of the holder frame 121 to be held on the upper end of the box body 111. The holder frame 121 is formed to a size that can hold a predetermined area of the outer circumference of the mobile terminal A. A mobile terminal exposure hole 123 is passed through inside the holder frame 121 to expose the liquid crystal screen of the mobile terminal A toward the convex lens 119.

An intermediate support 127 is provided at a central area of the mobile terminal exposure hole 123. The intermediate support 127 is disposed on the upper portion of the partition 115 and supports the central area of the mobile terminal A.

The box holding wings 125 are extended in a stepwise manner from the holder frame 121 to be held on the upper end of the box body 111. Accordingly, the mobile terminal support 120 is held on the partition 115, and both sides of the upper portion of the box body 111 and fixed in position.

The face connecting portion 130 is where the face of the user is contacted to see the stereoscopic images. The face connecting portion 130 is disposed to surround the lower portion of the terminal box 110 during use for the purpose of packing the mobile terminal A. That is, as illustrated in FIG. 1, the terminal box 110 is received in a stack-wise manner within the face connecting portion 130.

On the other hand, when the terminal packing box 100 is used as the stereoscopic image viewer, the face connecting portion 130 is coupled with the upper portion of the terminal box 110, as illustrated in FIG. 4.

The face connecting portion 130 ensures that the user's eyes are disposed at a predetermined distance apart from the mobile terminal A, and also guides so that the user can view the stereoscopic images more comfortably. To this end, the upper portion of the side surface of the face connecting portion body 131 is formed such that the face guide 132 is formed in a curved shape that corresponds to the facial contour of the face.

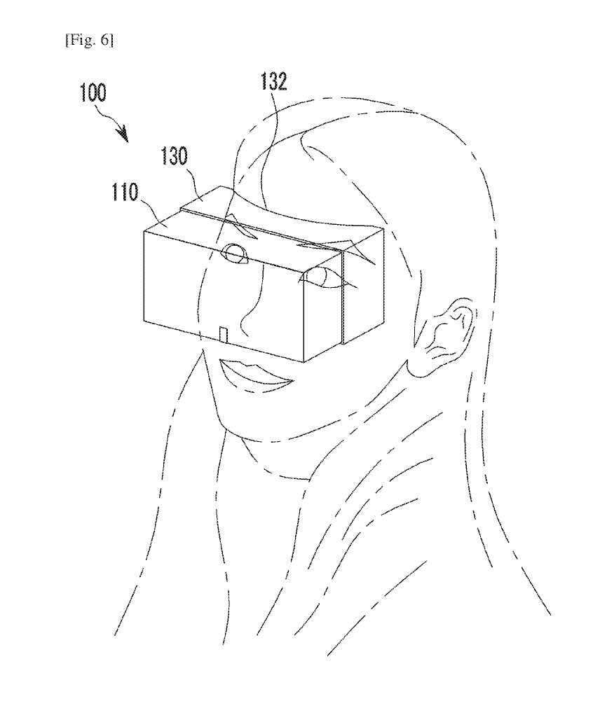

As illustrated in FIG. 6, the face connecting portion 130 is worn on the eye area of the user when the terminal packing box 100 is used as the stereoscopic image viewer. Accordingly, the upper portion of the face connecting portion 130 is disposed around the forehead of the user, and the lower portion is disposed around the nose area. Accordingly, the face guide 132 at the upper portion of the face connecting portion 130 is formed to correspond to the facial contour around the forehead area, and the face guide 132 at the lower portion is formed to correspond to the facial contour around the nose area. In this case, a nose insertion hole 132a is recessed at the central area of the face guide 132 formed at the lower portion such that the nose of the user is inserted therein.

Accordingly, the user can view the stereoscopic images for a long time without feeling inconvenience even when his or her face is in tight contact with the face connecting portion 130.

A pair of eye-contacting holes 133 for tight contact with the user's eyes are passed through a bottom surface of the face connecting portion body 131. A pair of eye-contacting holes 133 are disposed such that when the face connecting portion 130 is coupled with the upper portion of the terminal box 110, the eye-contacting holes 133 are located on the same axis as a pair of convex lenses 119.

A plurality of fastening protrusions 135 are protruded downward from the bottom surface of the face connecting portion body 131. As illustrated in FIG. 3, the fastening protrusions 135 are inserted into the face insertion holes 117 of the terminal box 110 such that the position of the face connecting portion 130 is restricted by the terminal box 110.

When the terminal packing box 100 is used for the purpose of packing the mobile terminal A, a packing material 140 wraps around the outer part of the face connecting portion 130 and the terminal box 110. The packing material 140 is made from a paper or synthetic resin material, and securely packed with adhesive or adhesive tape, and so on.

After purchasing the mobile terminal A, the user may remove the packing material 140 to separate the mobile terminal A from the terminal packing box 100.

The assembling process of the terminal packing box 100 configured as described above according to an exemplary embodiment used for the purpose of packing the mobile terminal A will be described with reference to FIGS. 1 and 2.

As illustrated in FIGS. 1 and 2, the terminal box 110 is received in the face connecting portion 130. The face connecting portion 130 is sized to receive the terminal box 110 therein. The face connecting portion 130 is preferably be formed in size that allows fitting with the terminal box 110.

The darkening layer 113 is formed on an inner surface of the terminal box 110, and the interior of the terminal box 110 is divided by the partition 115. The accessories associated with the mobile terminal A such as auxiliary battery, charger jack, headphone, and so on, are received in the interior of the terminal box 110 that is partitioned by the partition 115.

The mobile terminal support 120 is disposed on the upper portion of the partition 115. The box holding wings 125 on both sides of the mobile terminal support 120 are held on both upper ends of the box body 111 and fixed therein. The mobile terminal A is seated on the upper surface of the mobile terminal support 120 that is fixed in position.

The cover 112 is then engaged with the box body 111 and sealed. The lower portion of the terminal box 110 is surrounded by the protective cover 140 such that the convex lens 119 is prevented from contamination.

Meanwhile, after the user who purchased the mobile terminal A unpacks the packing material 140 and separates the mobile terminal A out, the user may reassemble as illustrated in FIG. 3 in order to utilize the terminal packing box 100 as a stereoscopic image viewer.

The face connecting portion 130 connected to the lower portion of the terminal box 110 is separated from the terminal box 110. A protective film (not illustrated) connected to the lower surface of the terminal box 110 is removed to thus expose the convex lens 119 to outside. The face connecting portion 130 is then connected to the lower surface of the terminal box 110. To this purpose, the fastening protrusions 135 are inserted into the face insertion holes 117 formed in the lower portion of the terminal box 110 to thus fasten the terminal box 110 with the face connecting portion 130.

In this case, the eye-contacting hole 133 is disposed on the same axis as the convex lens 119, and a plurality of fastening protrusions 135 are fastened into the face insertion holes 117.

The cover 112 is then opened, and the mobile terminal A playing a stereoscopic image as desired by the user is held on the mobile terminal support 120. At this time, the mobile terminal A is held on the mobile terminal support 120 such that the liquid crystal screen of the mobile terminal A is faced toward the convex lens 119.

The box holding wings 125 on both sides of the mobile terminal support 120 are loaded on the upper end of the box body 111, and the cover 112 is closed. The female Velcro 112a of the cover 112 is engaged with the male Velcro 111a of the box body 111 such that the cover 112 is restricted in the closed state.

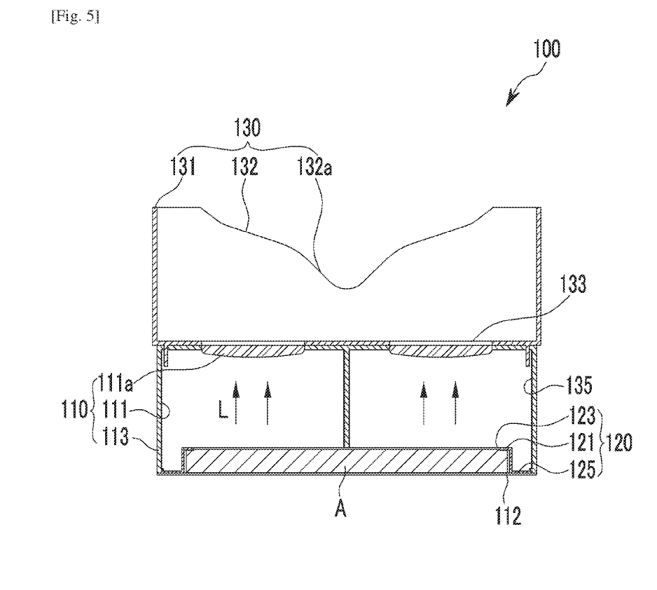

FIG. 5 is a cross sectional view illustrating a cross section of the terminal packing box 100 in the assembled state as the stereoscopic image viewer of FIG. 4, and FIG. 6 exemplifies the state in which the user is viewing the stereoscopic image with the terminal packing box 100.

As illustrated, when the terminal packing box 100 is assembled, the mobile terminal A that provides stereoscopic image can be conveniently inserted into the terminal packing box 100 and separated therefrom through the cover 112.

The stereoscopic image may preferably be in side-by-side format. Accordingly, when the user places his eyes on the eye-contacting hole 133 and sees stereoscopic image, the left-side image of the stereoscopic image in side-by-side format is seen only through the left eye of the user, while the right-side image is seen only through the right eye of the user. Specifically, since the left-side image and the right-side image are completely separated by the partition 115, the stereoscopic image in side-by-side format can be enjoyed with increased clarity and feeling of depth.

Further, since the darkening layer 113 darkens the interior of the terminal box 110, the stereoscopic image stands out bolding with increased clarity. Accordingly, user absorbance can be increased.

### MODE FOR CARRYING OUT THE INVENTION

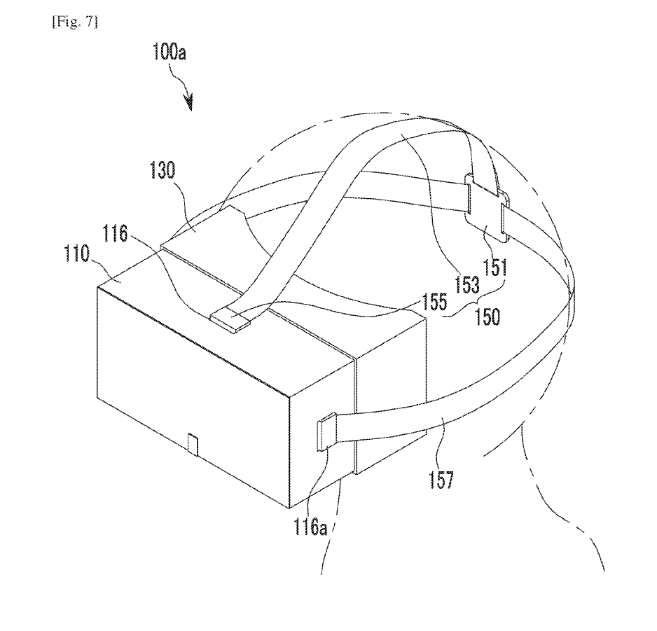

Meanwhile, FIGS. 7 and 8 are perspective views of the terminal packing box 100a according to another exemplary embodiment. With the terminal packing box 100 according to the exemplary embodiment described above, the user himself has to fix the terminal packing box 100 on his eyes when using the terminal packing box 100 as the stereoscopic image viewer. This can cause the user to feel fatigued on his arms especially when he has been viewing the stereoscopic images for a long period of time. Besides, the user is physically limited as he cannot move his hands freely.

The terminal packing box 100a according to another exemplary embodiment can be fixed to the head of the user with a box head fixing portion 150. As illustrated in FIG. 8, the box head fixing portion 150 includes a band fixing plate 151, an upper fixing band 153 engaged with the upper portion of the band fixing plate 151, and side fixing bands 157 engaged with both sides of the band fixing plate 151.

An upper fixing hook 155 and side fixing hooks 158 are provided respectively on the upper fixing band 153 and on ends of a pair of side fixing bands 157.

In this case, the box body 111 has hook insertion holes 116 for hook engagement with the upper fixing hook 155 and the side fixing hooks 158. The locking hooks 155a, 158a bent on ends of the upper fixing hook 155 and the side fixing hooks 158 are hook-engaged within the hook insertion holes 116 such that the terminal box 110 with the face connecting portion 130 attached thereto is kept in the fixed state on the face of the user.

In this case, the upper fixing band 153 and the side fixing bands 157 are preferably made from an elastic material for the sake of better fit.

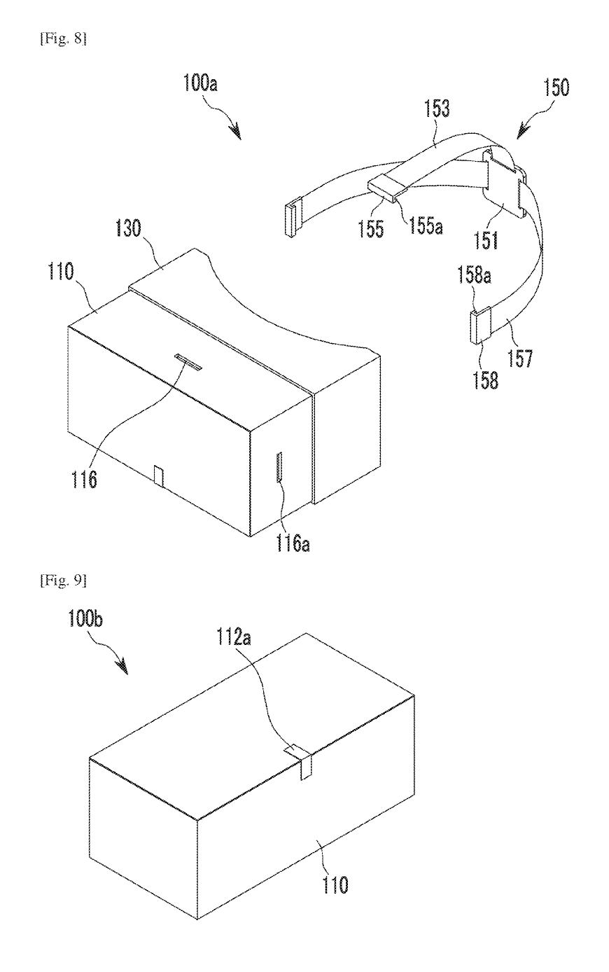

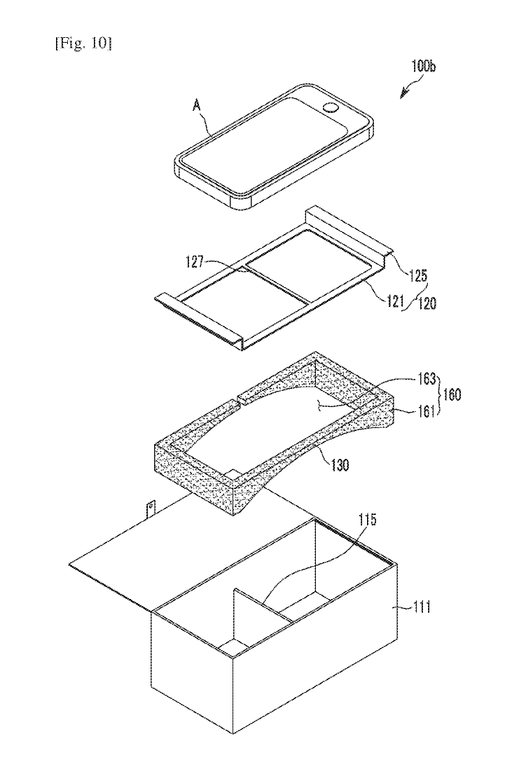

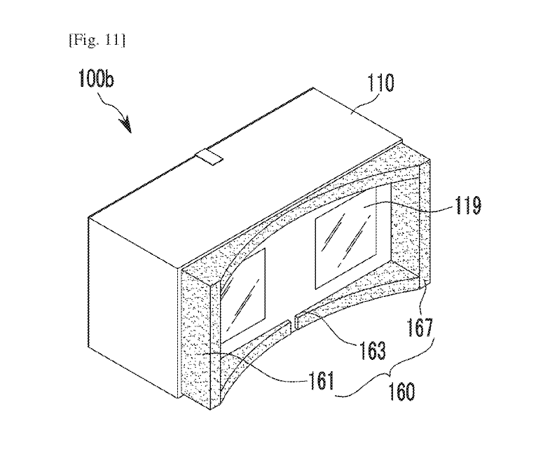

Meanwhile, FIGS. 9 to 11 are illustrations of the configuration of the terminal packing box 100b according to yet another exemplary embodiment. FIG. 9 is a perspective view illustrating an assembled state in which the mobile terminal A is packed, FIG. 10 is an exploded perspective view of the configuration in which the mobile terminal A is packed, and FIG. 11 is a perspective view of a state in which the terminal packing box 100b is used as the stereoscopic viewer.

In a state that the terminal packing box 100 described above is encasing the mobile terminal A, the face connecting portion 130 is disposed outside the terminal box 110. That is, the terminal packing box 100 is engaged with the face connecting portion 130 while being received in a stack manner.

On the other hand, according to another exemplary embodiment, the terminal packing box 100b is formed such that the face connecting portion 160 is received in the terminal box 110. In this case, the face connecting portion 160 is made from a material with elasticity and cushion, such as sponge, silicone, rubber, and so on. Accordingly, better user fit can be provided.

In this case, the face connecting portion 160 may be surrounded by a fabric face contact cover (not illustrated) to further increase the user fit of the face connecting portion 160 as it is brought into direct contact with the face of the user.

Meanwhile, in the terminal packing box 100 according to an exemplary embodiment, the terminal box 110 and the face connecting portion 130 are assembled with each other by the engagement between the fastening protrusions and the face insertion holes. However, this is provided only for illustrative purpose, and depending on embodiments, the fastening protrusions and the face insertion holes may not be provided, but dual-sided adhesive tape may be used for such fastening.

As described above, the terminal packing box according to the present disclosure can be used for packing the mobile terminal being shipped, and then used as a stereoscopic image viewer after reassembling process. This allows the user to assemble the stereoscopic image viewer with the terminal packing box, without having to separately purchase expensive stereoscopic image viewer.

Further, convenience of use is provided, since the user can assemble with only the terminal box and the face connecting portion being provided, without having to separately process the packing box.

Further, since the interior of the lower box is divided into two spaces by the partition, thus allowing the left-side image and the right-side image to be separately provided, the user's absorbance into the stereoscopic image can be increased.

Further, since the user can fix the terminal packing box on his head with the box head fastening portion, he can view the stereoscopic image conveniently for a long time.

The foregoing exemplary embodiments and advantages of a terminal packing box capable of viewing stereoscopic images are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

### INDUSTRIAL APPLICABILITY

The present disclosure relates to a terminal packing box, and is applicable to the manufacture and sales of a mobile terminal packing box.

1. A terminal packing box capable of viewing stereoscopic image comprising:
a terminal box encasing a mobile terminal; and
a face connecting portion connected in a manner of surrounding a lower portion of the terminal box, and comprising a pair of eye-contact holes passed therethrough,
wherein the terminal box comprises,
a box body to which a cover is openably engaged,
a partition vertically fastened within the box body to divide the box body into two spaces,
a pair of convex lenses fastened to the lower portion of the box body, and
a terminal support disposed between the partition and the cover to hold the mobile terminal thereon,
wherein, in an unpacked state in which the encased mobile terminal is released from the packed state, the face connecting portion is separated from the terminal box and assembled with the lower portion of the terminal box such that the terminal packing box is usable as a stereoscopic image viewer.

2. The terminal packing box of claim 1,
wherein the terminal box includes a plurality of face insertion holes passed through along an edge area,
wherein the face connecting portion includes a plurality of fastening protrusions protruding toward the lower portion to be inserted into the face insertion holes.

3. The terminal packing box of claim 2,
wherein the partition is fastened to the box body at a spacing from the cover that corresponds to a height for encasing the mobile terminal,
wherein the terminal support comprises,
a holder frame for contact-supporting an outer circumference of the mobile terminal, and including a terminal exposure hole passed therethrough to expose a liquid crystal screen of the mobile terminal to a direction of the convex lens, and
a box holding wings extending from both ends of the holder frame and seated on an upper end of the box body.

4. The terminal packing box of claim 3, wherein the terminal box includes a darkening layer formed on an inner surface of the terminal box.

5. The terminal packing box of claim 1, wherein the face connecting portion comprises a face guide formed on a side surface of the face connecting portion in a curved shape to correspond to a contour of a face of a user.

6. The terminal packing box of claim 5, wherein in the packed state, further comprising a packing material wrapped around an exterior of the terminal box and the face connecting portion being engaged in a stack manner to fix position.

7. The terminal packing box of claim 6, further comprising a box head fixing portion fixing the terminal box with the face connecting portion being connected thereto for use as a stereoscopic image viewer, onto the face of the user,
wherein a plurality of hook insertion holes are passed through a side surface of the terminal box,
wherein the box head fixing portion comprises,
a band fixing plate disposed on a back of a head of the user,
an upper fixing band extending from an upper portion of the band fixing plate to be fit into the terminal box, and
a pair of side fixing bands extending from both sides of the band fixing plate to be fit into the terminal box.

8. The terminal packing box of claim 1,
wherein the partition is fastened to the box body at a spacing from the cover that corresponds to a height for encasing the mobile terminal,
wherein the terminal support comprises,
a holder frame for contact-supporting an outer circumference of the mobile terminal, and including a terminal exposure hole passed therethrough to expose a liquid crystal screen of the mobile terminal to a direction of the convex lens, and
a box holding wings extending from both ends of the holder frame and seated on an upper end of the box body.

9. The terminal packing box of claim 1, wherein the terminal box includes a darkening layer formed on an inner surface of the terminal box.

10. The terminal packing box of claim 2, wherein the face connecting portion comprises a face guide formed on a side surface of the face connecting portion in a curved shape to correspond to a contour of a face of a user.

11. The terminal packing box of claim 3, wherein the face connecting portion comprises a face guide formed on a side surface of the face connecting portion in a curved shape to correspond to a contour of a face of a user.

12. The terminal packing box of claim 4, wherein the face connecting portion comprises a face guide formed on a side surface of the face connecting portion in a curved shape to correspond to a contour of a face of a user.
